(19) United States
(12) Patent Application Publication
(10) Pub. No.: US 2010/0074060 A1
(43) Pub. Date: Mar. 25, 2010

(54) Metal-cased motor vehicle stopwatch

(76) Inventor: Shih Hsiung Wu, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/379,887

(22) Filed: Mar. 4, 2009

(30) Foreign Application Priority Data
Sep. 24, 2008 (TW) 097217286

(51) Int. Cl. G04B 37/00

(52) U.S. Cl. 368/88

(57) ABSTRACT

A metal-cased motor vehicle stopwatch includes: a metal case of which the front side encloses a mouth from an opening fringe; a window sheet formed on a top side opposite to the mouth of metal case; and a frame body surrounding to form a frame orifice. The frame orifice is opposite to the mouth. The frame body is combined with the opening fringe of metal case. In the frame body, a section of portion is formed with a first convex portion towards the inside of frame orifice. With the buttons provided on the first convex portion, a user may operate conveniently.

### BACKGROUND OF THE INVENTION

1. Field of the Invention

This invention relates to a metal-cased motor vehicle stopwatch and particularly to a stopwatch enclosed with a metal case that is provided with buttons for easy operation.

2. Description of the Related Art

A conventional stopwatch used for motor vehicle, such as a motorcycle, a dune buggy, and an all-terrain vehicle, is a display tool that may display optionally one or more of mileage, speed (per hour), engine running speed, fuel gauge, temperature, neutral gear and lamp signal indication, engine oil status, or other dynamic and static status of the motor vehicle; besides quantized data, data, such as fuel gauge, mileage, engine running speed and the like, may be indicated in various forms; there are also parts of states that must be indicated by an indicator lamp, such as neutral gear, fuel out, turn signal, front and rear lamps and the like that are non-quantized indication. Although, for existing many stopwatches, plastics is generally injected into various elegant forms of watch cases that are inset or buried in the portions of heads of the motor vehicles, there are still many motorcycles, especially heavy motorcycles and race motorcycles of which the bodies are mostly enclosed with metal cases designed for a style, which are especially provided with classic metal-case stopwatch. Although part of the stopwatch is buried in a determined groove of the body of vehicle and the partial fringe of frame is exposed, the entire stopwatch is also exposed to show an alternative metallic style. With reference to FIG. 6, such a motor vehicle stopwatch (1) comprises a metal case (11). The bottom of metal case (11) is formed with a bottom plate (12). Buttons (121) are provided that passes through the bottom plate (12). Thus, in order to do adjustment, correct, or return to zero, a user must press the buttons (121) provided on the bottom plate (12) by his or her finger, which is inconvenient. Especially, the stopwatch (1) buried in the determined groove of the motor vehicle must be removed, or the user contacts deep into it by his or her finger. Even if the stopwatch is not buried, it is likewise inconvenient to operate the stopwatch that is alternately mounted with a support.

With further reference to FIG. 7, at the front side of metal case (11) provided in the prior art, a mouth (not shown) is enclosed from an opening fringe (111), and a frame body (13) is formed. The frame body (13) encloses a frame orifice (not shown). The frame orifice is opposite to the mouth. The frame body (13) is combined with the opening fringe (111) of metal case (11). The frame body (13) covers the opening fringe (111) and circularly bonds and seals the backside of opening fringe (111). The frame body (13) and the opening fringe (111) are metallic, if force is not evenly applied or the ductility of a metallic material is difficultly controlled in the process of circular bonding and sealing, so the backside is not evenly kept close. With reference to FIG. 7 illustrating two enlarged sections, the upper section shows a level-up close state and the lower section shows an irregular close state that causes a chink (A).

Consequently, because of the technical defects of described above, the applicant keeps on carving unflaggingly through wholehearted experience and research to develop the present invention, which can effectively improve the defects described above.

### SUMMARY OF THE INVENTION

In consideration of the mentioned-above defects of prior art, this inventor considers to make improvement. Thus, a metal-cased motor vehicle stopwatch comprises: a metal case of which the front side encloses a mouth from an opening fringe; a window sheet formed on a top side opposite to the mouth of metal case; and a frame body surrounding to form a frame orifice. The frame orifice is opposite to the mouth. The frame body is combined with the opening fringe of metal case. In the frame body, a section of portion is formed with a first convex portion towards the inside of frame orifice. Buttons are provided on the first convex portion. With the buttons provided on the first convex portion, a user may operate conveniently.

A plurality of locking holes opposite to each other are formed on the frame body and the opening fringe of metal case for a plurality of joint parts to lock each other. The two portions may be locked to each other one by one or together by the plurality of joint parts, so the lock surface is flat, and even if it is not flat, adjustment may be made for achievement of balanced locking, and then reduction of probability of water infiltration.

### BRIEF DESCRIPTION OF THE DRAWINGS

FIG. 1 is a 3D view of this invention;

FIG. 2 is an exploded view of this invention;

FIG. 3 is a schematic view illustrating the operation status of this invention;

FIG. 4 is a 3D sectional assembly view of this invention;

FIG. 5 is a 3D exploded view of another embodiment of this invention;

FIG. 6 is a 3D view of the back side of structure formed in the prior art; and

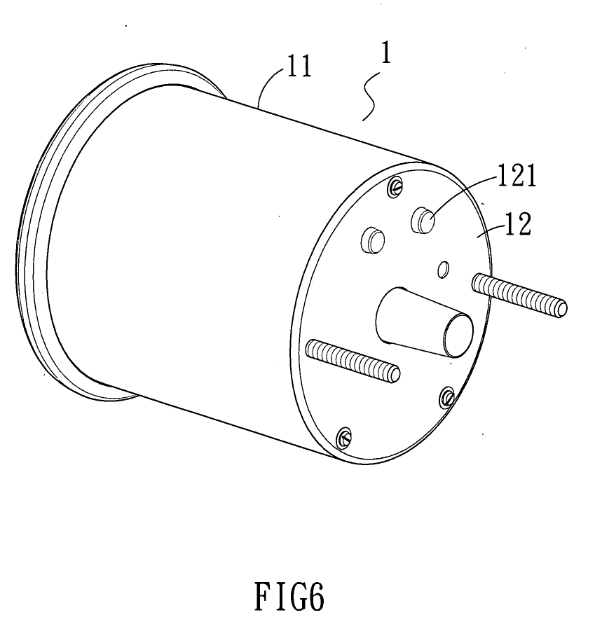

FIG. 7 is a side view and a enlarged sectional view of the structure in the prior art.

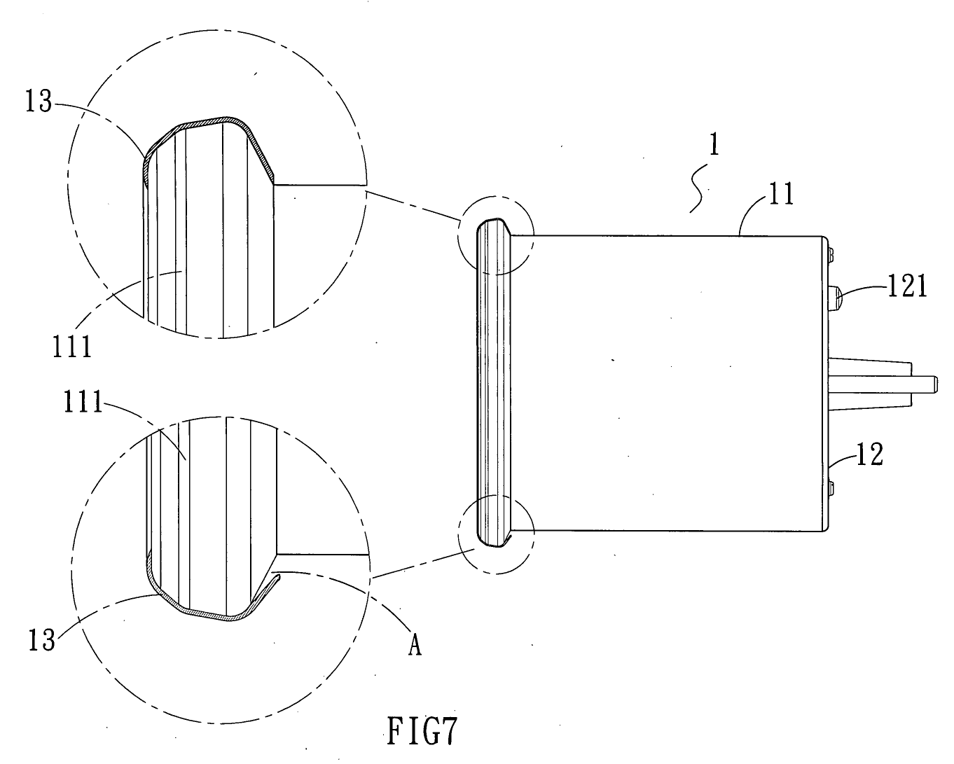

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

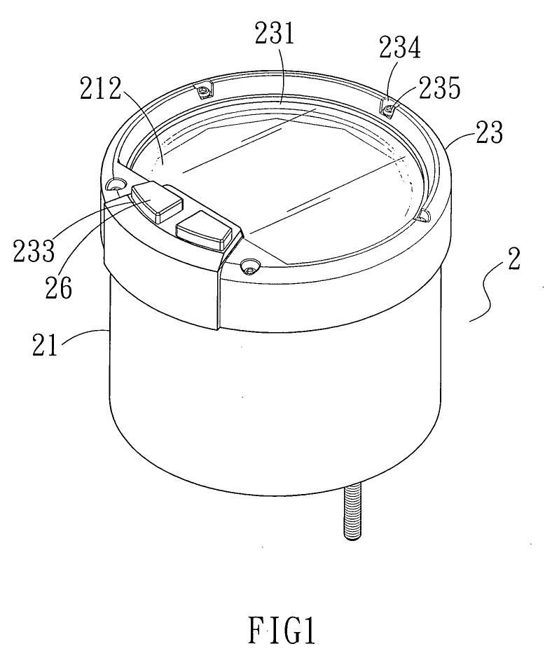

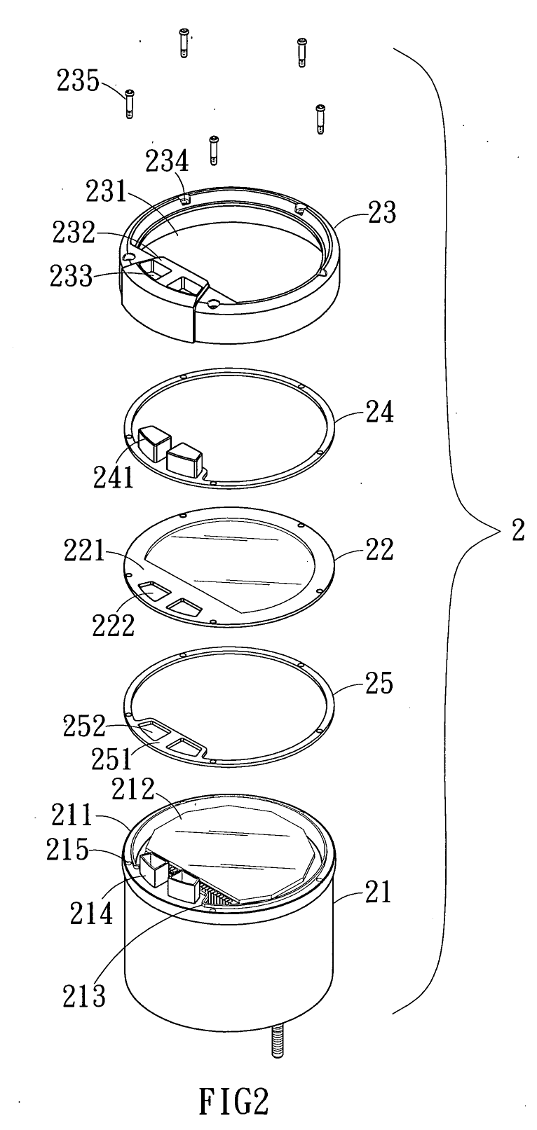

Refer to FIG. 1 shown as a completely exploded view of a metal-cased motor vehicle stopwatch (2). With reference to FIG. 2, the stopwatch (2) comprises a metal case (21), a window sheet (22), and a frame body (23).

The front side of metal case (21) encloses a mouth (212) from an opening fringe (211).

The window sheet (22) is formed on a top side opposite to the mouth (212) of metal case (21).

The frame body (23) surrounds to form a frame orifice (231). The frame orifice (231) is opposite to the mouth (212). The frame body (23) is combined with the opening fringe (211) of metal case (21). In the frame body (23), a section of portion is formed with a first convex portion (232) towards the inside of frame orifice (231). Buttons are provided on the first convex portion, as shown in FIG. 1.

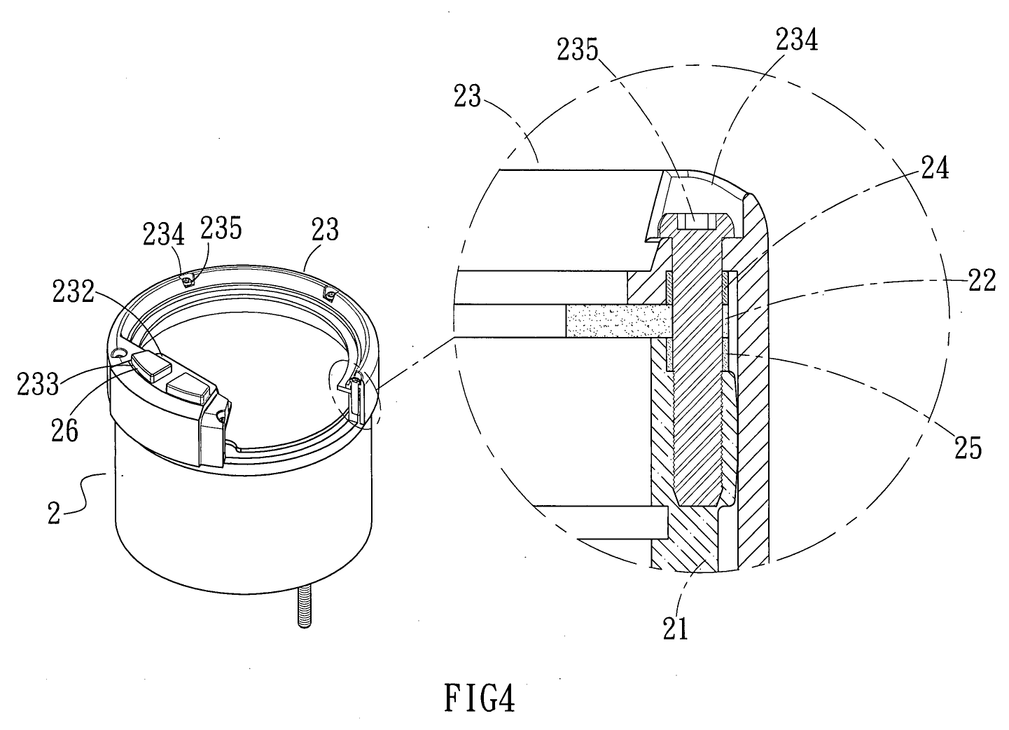

With reference to FIGS. 2 and 4 illustrating an embodiment of this invention where the buttons (26) are provided on the convex portion (232), a thru hole (233) is formed on the first convex portion (232). A first ring pad (24) is provided at the bottom of frame body (23). The first ring pad (24) is provided with a button shell (241) of which a mouth facing downward is opposite to the first thru hole (233). Around the window sheet (22), a second convex portion (221) opposite to the first convex portion (232) is formed. The second convex portion (221) is formed with a second thru hole (222) opposite to the button shell (241). At a section of the opening fringe (211) of metal case (21), a third convex portion (213) is formed towards the mouth (212). A button body (214) is provided on the third convex portion (213). The button body (214) passes through the second thru hole (222) to the button shell (241). The button shell (241) is exposed from the first thru hole (233).

In a further embodiment, a second ring pad (25) is provided under the window sheet (22). The second ring pad (25) is provided with a fourth convex portion (251) opposite to the second convex portion (221) of window sheet (22). The fourth convex portion (251) is formed with a third thru hole (252) opposite to the second thru hole (222).

Further, in this invention, a plurality of locking holes (234) and (215) opposite to each other are formed on the frame body (23) and the opening fringe (211) of metal case (21) for a plurality of joint parts (235) to lock each other.

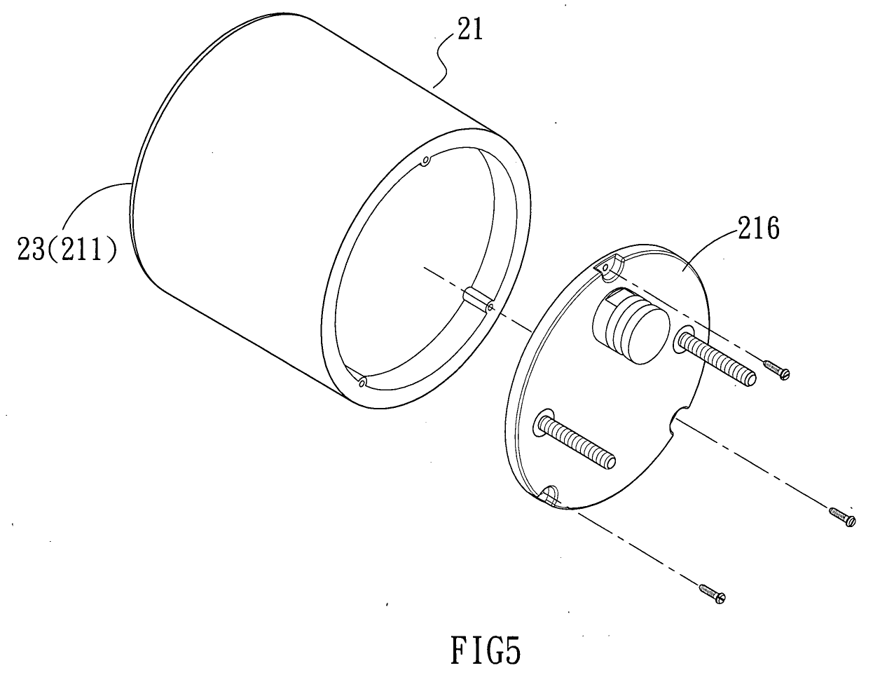

With reference to FIG. 5, in this invention, the frame body (23) and the opening fringe (211) of metal case (21) may also stretch together. The metal case (21) is provided with a bottom plate (216) that may be unlocked and removed.

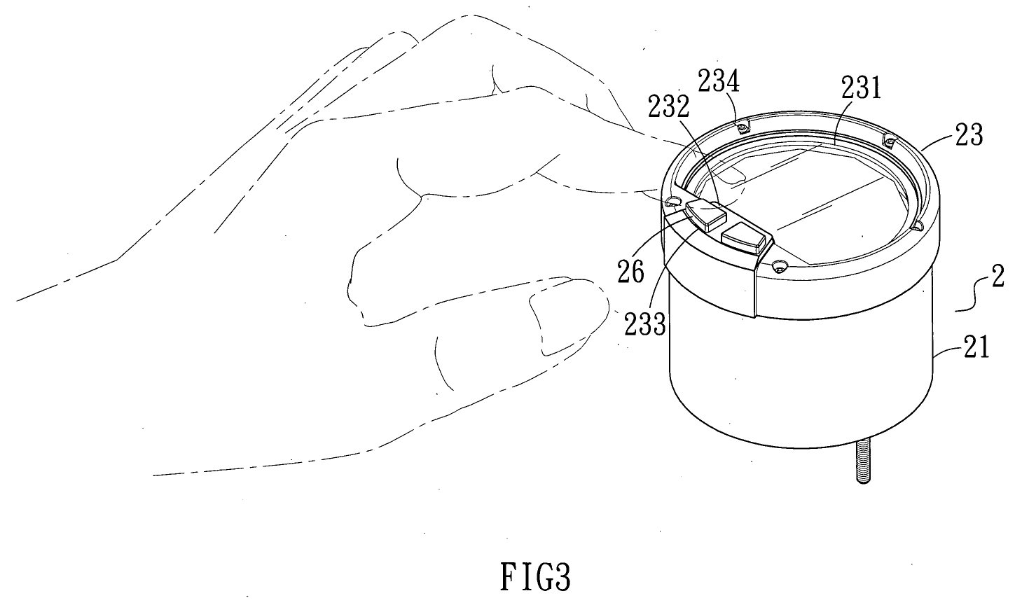

With reference to FIG. 3, in this invention, the buttons (26) are provided on the first convex portion (232) of the frame body (23), so the user may operate conveniently by his or her finger. It is apparent in FIGS. 1 and 2 that the plurality of locking holes (234) and (215) opposite to each other are formed on the frame body (23) and the opening fringe (211) of metal case (21) for the plurality of joint parts (235) to lock each other.

The two portions may be locked to each other one by one or together by the plurality of joint parts (235), so the lock surface is flat, and even if it is not flat, adjustment may be made for achievement of balanced locking, and then reduction of probability of water infiltration. With reference to FIG. 4, in this invention, a preferred waterproof effect is achieved in the condition of detailed layer-by-layer structure.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A metal-cased motor vehicle stopwatch, comprising:
a metal case of which the front side encloses a mouth from an opening fringe;
a window sheet formed on a top side opposite to the mouth of metal case; and
a frame body surrounding to form a frame orifice, in which the frame orifice is opposite to the mouth, the frame body is combined with the opening fringe of metal case, in the frame body, a section of portion is formed with a first convex portion towards the inside of frame orifice, and buttons are provided on the first convex portion.

2. The metal-cased motor vehicle stopwatch according to claim 1, wherein a plurality of locking holes opposite to each other are formed on the frame body and the opening fringe of metal case and oppositely locked by a plurality of joint parts.

3. The metal-cased motor vehicle stopwatch according to claim 1, wherein the frame body and the opening fringe of metal case are combined with each other and stretch together.

4. The metal-cased motor vehicle stopwatch according to claim 1, wherein a thru hole is formed on the first convex portion where the button is provided, a first ring pad is provided at the bottom of frame body, the first ring pad is provided with a button shell of which a mouth facing downward is opposite to the first thru hole, around the window sheet, a second convex portion opposite to the first convex portion is formed, the second convex portion is formed with a second thru hole opposite to the button shell, at a section of the opening fringe of metal case, a third convex portion is formed towards the inside of mouth, a button body is provided on the third convex portion, the button body passes through the second thru hole to the button shell, and the button shell is exposed from the first thru hole.

5. The metal-cased motor vehicle stopwatch according to claim 1, wherein a second ring pad is provided under the window sheet, the second ring pad is provided with a fourth convex portion opposite to the second convex portion of window sheet, and the fourth convex portion is formed with a third thru hole opposite to the second thru hole.
